(19) United States
(12) Patent Application Publication
(10) Pub. No.: US 2005/0080725 A1
(43) Pub. Date: Apr. 14, 2005

(54) Banking systems

(76) Inventor: Elizabeth Jane Pick, London (GB)

Correspondence Address: FLYNN THIEL BOUTELL & TANIS, P.C., 2026 RAMBLING ROAD, KALAMAZOO, MI, 49008-1699, US

(21) Appl. No.: 10/914,685

(22) Filed: Aug. 9, 2004

(30) Foreign Application Priority Data
Aug. 7, 2003 (GB) 0318570.9

(51) Int. Cl. G06F 17/60

(52) U.S. Cl. 705/39; 705/42

(57) ABSTRACT

A method is provided for operating a bank account. In this, a deposit is received into the account and a preselected percentage of the deposit is transferred to a second account. Alternatively, a part of the deposited sum corresponding to a preselected percentage can be allocated to at least one fund within the account.

This invention relates to banking systems and in particular to systems for operating bank accounts where some sub-division of sums deposited is required.

Bank accounts known as sweep accounts are currently available and operate on the basis that any sum deposited in excess of an amount nominated by the account holder can be diverted into e.g. a savings account. Some such accounts also have the ability to sub-divide sums deposited into e.g. a specific savings account such that a fixed amount is paid each month into one of the savings accounts or funds nominated by the account holder.

Persons who are self-employed or others that have incomes which vary on a regular basis, e.g. contract workers encounter difficulties in making regular payments out of their bank accounts to e.g. a pension fund or a reserve fund for tax because all the existing systems work on the basis that fixed sums are transferred at regular intervals, e.g. monthly standing orders.

These people need to reserve an income to cover tax liabilities, to pay for pension savings, sales taxes etc. However, these sums are not predictable but are calculated as a percentage of income. As the income of certain types of people may vary considerably from month to month, saving a fixed amount each month is unlikely to permit effective management of finances for these people in order to cater for tax and other liabilities. A fixed sum allocated each month to e.g. tax and pension might lead to the person not having saved enough or having saved too much. Also, if the fixed amount is saved each month then in some months the account holder may earn less than the amount of the standing order, or would be left with insufficient funds to live on.

Preferred embodiments of the present invention provide a banking system which enables funds to be portioned as a percentage of sums deposited.

In a preferred embodiment, a bank account is provided from which a fixed percentage of all or of part of the income is transferred to a separate account when it is deposited.

In another preferred embodiment, a banking system is provided in which an account is sub-divided by a percentage of all or part of funds deposited.

Preferred embodiments of the invention will now be described in detail by way of example with reference to the accompanying drawings in which:

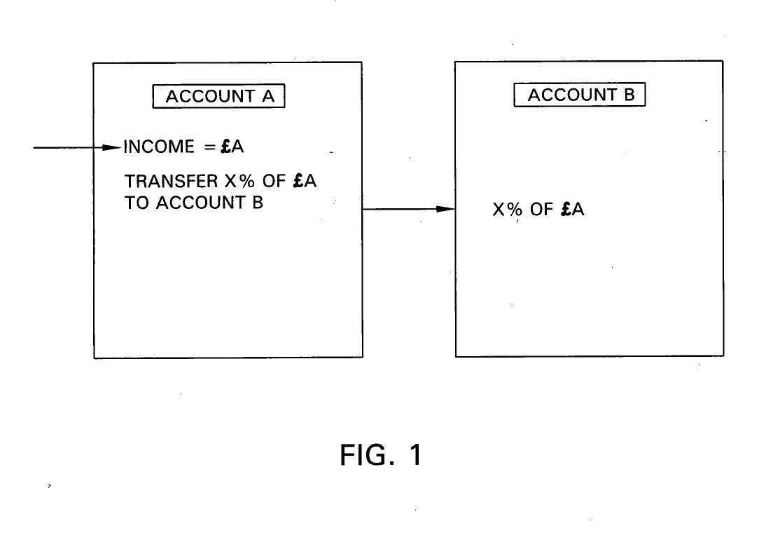

FIG. 1 shows schematically a first embodiment of the invention;

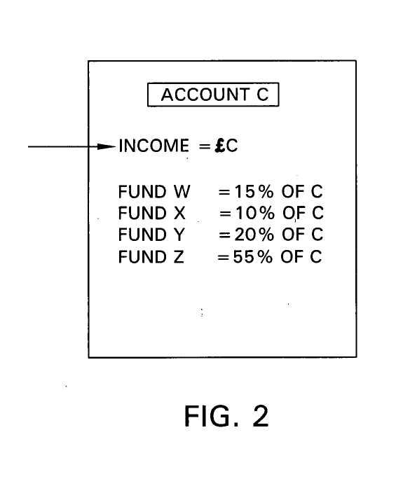

FIG. 2 shows schematically a second embodiment of the invention.

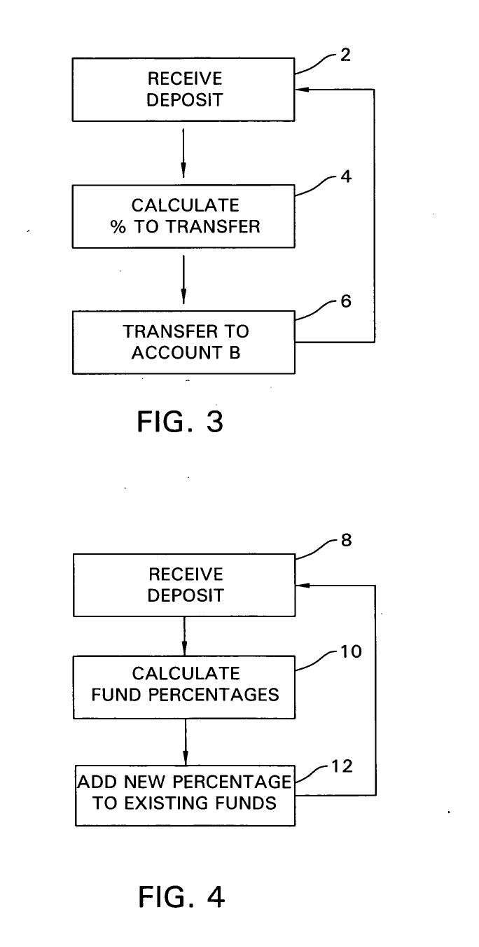

FIG. 3 is a flow diagram showing the operation of the embodiment of FIG. 1; and

FIG. 4 is a flow diagram showing the operation of the embodiment of FIG. 2.

In the embodiment shown in FIG. 1, if a bank account is provided which allows the transfer of a fixed percentage of income to a separate account. This would be used by e.g. a self-employed person who wanted to ensure that a sufficient amount of money has been put aside for e.g. VAT, income tax, pension payment. For example, in the United Kingdom they wish to reserve 17.5% for VAT. 30% for income tax, 20% for pension savings. This would make a total of 67.5% of monthly income.

The bank account provides the facility for the account holder to instruct the bank to transfer a fixed percentage of all deposits to a separate savings account. In this case, an instruction to transfer 67.5% of all income into a savings account would be provided. This would then enable the account older to have approximately the correct amount saved for paying these items, irrespective of their income.

Should there be a desire to make additional transfers then these could be on a fixed sum basis if required either to the same or to different accounts.

The operation of such an account is shown schematically in FIG. 1. In this an income sum A is deposited into Account A. A fixed percentage X of this is then transferred to Account B. The account may transfer different percentages to more than one account.

Those familiar with tax law will know that income tax rates vary according to total income. Therefore, a modified version of this account could be provided in which a variable percentage could be put aside for income tax depending on total income to the account from the beginning of a current tax year. Therefore, in a tax system with two bands of income tax the first percentage would be transferred up to the threshold between the two levels and once the total deposits have exceeded that threshold, a second higher percentage would be transferred.

This happens everytime a deposit is made to Account A.

FIG. 2 shows schematically an account which sub-divides income into funds in accordance with a calculated percentage of income deposited in the account. The figure shows Account C which has income deposited in it and divides this into four separate funds, W, X, Y, and Z and to which 10, 15, 20, and 55 of the deposited amount are allocated respectively. When the account holder receives a statement on this account it is sub-divided to show the amount allocated to each fund. This avoids the need to have a plurality of savings accounts for different purposes which would be cumbersome and would probably result in a lower rate of interest.

In the example of Account C in FIG. 2, when income is received an amount is allocated to a VAT fund, an income tax fund, a pension fund, and a residual fund, on a percentage basis. In addition fixed sum transfers could be received and shown separately and not allocated to the various funds.

When a withdrawal is made on such an account, the account holder can select from which fund he is making a withdrawal so that when he has his tax bills, he can make sure that the amounts he withdraws is drawn on the tax fund.

In a further embodiment, a bank account can be provided which combines both of the systems proposed above. Thereby allowing the sub-division of its income into funds and which also pays interest on the total balance.

With employees who are paid commission, bonuses, etc. variable accounts of the type described above are extremely useful. Such an account is arranged to identify payments from the person=s employer. These may be either 100% variable income or a mixture of fixed and variable income. The account is arranged so it that it has the options to:
a) transfer a percentage of all payments to another account; and/or
b) sub-divide the balance of the account on a percentage basis.

Payments from other sources can be added to the account in the usual way or can be nominated as also being transferred or split on a percentage basis.

For an employed person, with a fixed income, they may find there are annual increases or decreases in income. If it is decided to set aside money for e.g. holidays, the deposit for a house, etc. then as the income increases they will wish to change any standing orders for savings each year as they are able to afford more. Using an account of the type described here this becomes unnecessary since it is possible to nominate a fixed percentage of income to be sent to a savings account or allocated to a different fund, therefore allowing people to save in proportion to their income and removing the need to change savings arrangements each time a pay rise or reduction is received.

Accounts such as those described here are attractive to banks since they wish to provide services to people with variable incomes. There are approximately 3 million self-employed people in the United Kingdom and 12 million in the USA. At present, no bank is able to offer an account of this type.

Thus the provision of such an account will make a bank attractive to self-employed persons and others wishing to operate accounts on this basis. The account is easy and cheap to implement using existing IT systems. Customers will be more likely to retain higher balances in their accounts as they reserve funds for tax etc. rather than transfer them to interest varied accounts elsewhere. There will be fewer transactions overall.

Self-employed persons may choose to use such an account as a combined business and personal account. This will result in fewer accounts to be managed by the bank. Also, customers are less likely to hold their business in current accounts and separate banks.

For self-employed people, such an account brings improved financial management and planing. For example, there is no need to transfer funds for tax etc. into higher interest accounts elsewhere. Also, information available from the account will be based on actual incomes as opposed to expected income and which results in less paperwork for the account holder. If such accounts are commonly used then, it will result in tax bills, national insurance and VAT payments being more likely to be paid on time since the accounts will encourage people to make the necessary reserves. Also, pension provision for these people may be better in the future.

Embodiments of the invention can be implemented using existing banking computer Systems loaded with software written to implement accounts of the type described above.

FIG. 3 shows a flow diagram of the operation of the account illustrated in FIG. 1. In this, a deposit is received at 2, The computer system monitoring the account calculates the percentage of the deposit to transfer to account B at 4 and then makes this transfer at 6. The system is then ready to receive further deposits at 2.

FIG. 4 shows how the embodiment of FIG. 2 would operate. At 8, a deposit is received. The computer system monitoring the account then calculates at 10 the percentages for each fund nominated by the account holder into which the deposit is to be divided. At 12 these new percentage sums are added to the existing sums in each fund and are stored. Thus, when it is necessary to produce a statement from the account the mount allocated to each fund is readily available.

1. A method of operating a bank account comprising the steps of:
receiving a deposit; and
transferring a pre-selected percentage of the deposit to a second account.

2. A method according to claim 1 in which the pre-selected percentage is selected by the account holder.

3. A method according to claim 1 including the step of transferring pre-selected percentages to more than one other account.

4. A method of operating a bank account comprising the steps of:
receiving a deposit; and
allocating at least a part of the deposited sum to at least one fund within the account the part comprising a preselected percentage of the deposited sum.

5. A method according to claim 4 in which at least part of the deposited sum is allocated to two or more funds within the account in pre-selected percentages.

6. A method according to claim 4 in which the total sum deposited is allocated to funds within the account in pre-selected percentages.

7. A method according to claim 6 in which the percentages are pre-selected by the account holder.
